(19) United States
(12) Patent Application Publication
(10) Pub. No.: US 2024/0359254 A1
(43) Pub. Date: Oct. 31, 2024

(54) ELECTRON BEAM WELDING METHODS AND APPARATUS

(71) Applicant: TWI Limited, Cambridge (GB)

(72) Inventors: Colin RIBTON, Cambridge (GB); Vitalijs JEFIMOVS, Cambridge (GB)

(21) Appl. No.: 18/684,439

(22) PCT Filed: Aug. 3, 2022
(86) PCT No.: PCT/GB2022/052043

§ 371 Date: Feb. 16, 2024

(30) Foreign Application Priority Data
Aug. 18, 2021 (GB) 2111837.7

(51) Int. Cl. B23K 15/00

(52) U.S. Cl. CPC B23K 15/002; B23K 15/004; B23K 15/008

(57) ABSTRACT

A method of electron beam welding a plurality of secondary components to a primary component. The method comprises: (a) on a first weld path which defines a respective section of the primary component to be welded to a first secondary component, forming, by electron beam welding, a spot weld which joins the primary component and the first secondary component at a respective spot weld location on the first weld path; and (b) on a second weld path which defines a respective section of the primary component to be welded to a second secondary component, forming, by electron beam welding, a spot weld which joins together the primary component and the second secondary component at a respective spot weld location on the second weld path. Each of steps (a) and (b) is repeated at least once, in any order, so as to form, on each of the first and second weld paths, a respective set of contiguous spot welds arranged along the respective weld path. Each successive spot weld is formed while one or more of the previous spot welds is solidifying and only after any existing spot weld(s) with which it is contiguous has solidified.

### FIELD OF THE INVENTION

The present invention relates to a method of electron beam welding a plurality of secondary components to a primary component and apparatus for performing such methods. The disclosed methods and apparatus find particular application in the context of manufacturing devices that require many secondary components to be joined to a primary component such as when forming electrical connections between the components of electric vehicle battery packs.

### BACKGROUND TO THE INVENTION

Impending regulation and the shift away from using fossil fuels has magnified the interest in replacing vehicles powered by internal combustion engines, particularly with electrically powered vehicles. Of the various methods for storing energy in a portable fashion for use in these vehicles, battery technology appears to be the most promising, in particular the use of secondary batteries, which can be recharged for repeated use (e.g. varieties of lithium ion batteries in large packs). Battery packs are relatively complex structures that require multiple welds between a variety of materials, typically similar and dissimilar metal joints, including individual cell tab to busbar/collector plate joints, terminal joints and contact points between batteries, containers and thermal management systems. In terms of the electrically conducting joints (e.g. tab to busbar, terminal joints) it is particularly important for the joints to maintain a high level of electrical conductivity, which is affected by metallurgical (e.g. grain structure, formation of intermetallic compounds between dissimilar metals) and physical joint properties (e.g. presence of oxides, corrosion, mechanical damage). Thermal input during the joining process can affect the aforementioned properties and also damage or ignite the chemicals present in the battery cells.

When selecting a suitable welding technique for joining together the components of a battery assembly, various factors are taken into consideration, including the resulting joint properties, thermal input, cycle time, mechanical input, capital investment, ease of automation and process flexibility. Laser welding is currently seen as a front-runner technology for forming the electrically conducting joints on batteries as it is a non-contact (no mechanical input), high precision and controllable (in particular in terms of the positioning of the laser beam and the heat input delivered to the site of the weld) process, with readily available automatable equipment. However, because laser beams are optical radiation, they must be either directly mechanically manipulated at source or deflected using mirrors, fibres and other optical media. Also, focusing must be performed using mechanical movement of optical lenses as the beam is deflected to a new position, which limits the ability of a laser beam spot to ‘settle’ before welding commences.

In addition to laser welding, other welding techniques are known and include resistance spot welding, ultrasonic welding, friction stir welding and electron beam welding. Electron beam welding belongs to the more general family of electron beam processing methods, which are a family of processes that find utility in applications such as thick-section welding and the production of very fine surface features. Electron beam processing typically takes place under a degree of vacuum, which prevents scattering of electrons and has the advantage of preventing atmospheric pollution. Electron beam welding of electrical connections has been attempted previously: for example, U.S. Pat. No. 9,375,804 relates to electron beam welding of lithium ion battery connections in a pouch battery, whereby a weld is formed through a stack of current collectors held in a (optionally actively cooled) clamping mechanism, and with an oxygen-free atmosphere to avoid oxide formation. The welding process described is suitable for joining of foils in battery cell production, but the method of using clamps to effect ‘masking’ of the foil joint region would not be suitable for joining of a plurality of components not provided as a stack at any reasonable speed or power input, or provided in any great number.

One particular reason that it is thought not feasible to utilise electron beam welding is due to a phenomenon known as ‘humping’, where a seam weld exhibits a humped or highly rippled surface due to displacement of molten material during beam traversal. Whilst this phenomenon can be used advantageously in electron beam techniques such as “Surfi-Sculpt” (see EP-B-1551590), where it is used to texture the surface of the workpiece being treated, it is generally disadvantageous in the formation of welds since the development of the “humped” surface profile is typically chaotic, which results in substantial inconsistencies between the properties of the affected welds. In order to mitigate the detrimental effects of humping on extended welds, it is necessary to form welds of this kind slowly, and this prevents electron beam welding from operating at the speeds required to form a large number of welds between a number of components, e.g. when welding electrically conductive members on battery packs. For these reasons, electron beam welding has generally been dismissed as unsuitable for welding together large numbers of components as required in the manufacture of complex products such as battery assemblies.

In light of the drawbacks associated with known laser and electron beam welding techniques, there is a need for a way of producing consistent, high quality welds for joining together large numbers of components at high speeds.

### SUMMARY OF THE INVENTION

A first aspect of the invention provides a method of electron beam welding a plurality of secondary components to a primary component, the method comprising:
(a) on a first weld path which defines a respective section of the primary component to be welded to a first secondary component, forming, by electron beam welding, a spot weld which joins the primary component and the first secondary component at a respective spot weld location on the first weld path;
(b) on a second weld path which defines a respective section of the primary component to be welded to a second secondary component, forming, by electron beam welding, a spot weld which joins together the primary component and the second secondary component at a respective spot weld location on the second weld path; and
repeating each of steps (a) and (b) at least once, in any order, so as to form, on each of the first and second weld paths, a respective set of contiguous soot welds arranged along the respective weld path, wherein each successive spot weld is formed while one or more of the previous spot welds is solidifying and only after any existing spot weld(s) with which it is contiguous has solidified.

While known electron beam welding techniques such as that disclosed in U.S. Pat. No. 9,375,804 are limited in speed due to the detrimental “humping” effect described above, electron beam welding has several characteristics that would be highly beneficial in the manufacture of products which comprise multiple components joined to one another if only they could be fully exploited in this context. For example, electron beams can be operated over a wide power range, and are far less susceptible to being reflected by the materials being welded than lasers: whereas laser beams are often reflected in an unpredictable manner, electron beams reliably deliver energy to the site on which the beam is incident in a predictable fashion that is virtually independent of the properties of the surface. In addition, because of the ability to manipulate electron beams using electromagnetic coils, they can be extremely rapidly positioned, traversed and focused. The ability to rapidly position, traverse and focus the electron beam is particularly desirable when joining a plurality of components together since this reduces the time spent traversing the beam between different weld locations and thus increases the effective welding speed that can be attained. By contrast, laser-based techniques suffer several disadvantages in addition to the speed impediment described above, and overcoming these limitations would be advantageous. Lasers also suffers a severe materials-related drawback in that materials such as copper and aluminium reflect laser radiation, which affects weld consistency in terms of penetration and overall quality. Moreover, the proportion of the radiation reflected depends on the particular geometry of the beam and the irradiated surface, and is thus unpredictable. This can cause significant inconsistencies between the properties of welds formed.

The inventors have realised that the detrimental “humping” effect can be mitigated by joining the primary and secondary components by a series of spot welds, each of which is allowed to solidify before any subsequent spot welds contiguous with it are produced. A “spot weld” is formed when the electron beam is focused onto a point, or “spot weld location”, on the primary component or the secondary component to be joined to it and then kept substantially stationary while the irradiated area begins to melt due to the heat generated at the spot weld location by the incident electron beam. This results in the formation of a molten area—or spot—of material from the primary and/or secondary components that corresponds in shape and size (but is not necessarily exactly equal) to the cross-section of the electron beam. Once the electron beam is removed, for example by traversing it to a different point that is substantially not thermally influenced by the first, now-melted point, the molten material will begin to cool and solidify, thus forming a “spot weld” that joins the primary and secondary components. Spot welds are distinguished from extended welds (for example seam welds), which are formed when an extended zone of molten material is produced by traversing the beam across the component to be joined. In terms of the longitudinally sectioned microstructure of joints formed from contiguous spots versus a seam weld, it is discernible that joint formed from contiguous spots will have multiple identifiable solidification boundaries i.e. at least one for each spot weld formed, whereas the joint formed from a seam weld would have only boundaries surrounding the seam as a whole.

For each secondary component to be joined to the primary component, a respective weld path is defined which comprises the set of spot weld locations, at each of which a respective spot weld will ultimately be formed. Each weld path may be a continuous path and defines the shape of the weld to be formed between the respective secondary component and the primary component. The spot weld locations of each weld path are arranged such that the set of spot welds formed on that weld path are, once all formed, contiguous and thus together form the extended weld which joins the secondary component to the primary component. To say that a set of contiguous spot welds is formed does not necessarily mean that all of the spot welds on that path are contiguous with one another—for example, in some preferred embodiments the spot weld locations may be arranged along a line or curve such that each spot weld is contiguous only with the two spot welds either side of it (other than those at the ends, in the case of a line which has separate ends, which will be contiguous with only one other spots weld). While each secondary component will be joined to the primary component by at least one respective weld path, the method does not preclude the possibility of some or all secondary components being joined to the primary component by multiple weld paths, which can be formed as part of the same method by exactly the same principle. Although the method requires welding at least two secondary components to the primary component, it is capable of joining any higher number of secondary components to the primary component.

While forming the sets of spot welds in the manner defined above would incur a significant reduction in effective welding speed when performed by laser welding (due to the need to physically move the lenses or other optical infrastructure used to direct the beam each time the laser beam is moved to the spot weld location of the next spot weld to be formed), it does not significantly impede the welding speeds attainable by the present invention. This is enabled by the fact that electron beams are manipulated by electromagnetic fields, generated for example by an electrical coil, which can be changed almost instantaneously by controlling the current which gives rise to them and without needing to physically move apparatus such as lenses or other optical structures. Indeed, because the time taken to traverse the electron beam between spot weld locations is relatively small (in comparison to the time taken to form each spot weld), methods in accordance with the present invention have been found to be significantly faster at joining a plurality of secondary components to a primary component than are conventional laser-based techniques. These factors lead to a significant speed advantage when compared to the laser welding a plurality of secondary components to a primary component across an array of positions, especially when considering the welding of upward of for example 3,000 cells that may be present in a modest electric vehicle battery pack.

As will be discussed below, the welded region formed by each set of contiguous spot welds may take the form of a straight line, Z-shape, circle or other form so as to bond the workpieces of each component.

The method may involve performing electron beam traverses to one or more other secondary components between forming the first spot weld on the secondary component that is welded in the first iteration of step (a) or (b) and returning to that secondary component when step (a) or (b) is next repeated. For example, forty spot weld locations could be visited, forming a respective spot weld at each one, before returning to the first weld path (e.g. to form a spot weld contiguous with the first spot weld that was formed on the first weld path). Because the traverse speed of the electron beam can be so high, the beam can be fully utilised in forming spot welds of thousands of components in sequence. A typical spot solidifying time may be of the order of 10 milliseconds, but an electron beam can be traversed at speeds approaching 10,000 metres per second, with a visit at each spot for as little as 0.25 milliseconds to melt to a depth of 0.1 to 1 millimetres in copper to steel (for example copper cell tabs/collector plates to steel cell casings) and similar speeds for copper to aluminium (for example copper cell tabs/collector plates to aluminium bus bar), but utilising a higher power beam. Whilst the melted regions on one component are solidifying, the beam can be visiting many other components. A similar technique is not particular feasible using a laser, due to the aforementioned lower traverse and focusing speed.

As noted above, steps (a) and (b) are repeated in any order. It is therefore possible for two or more spot welds in immediate succession to be formed on the same weld path, or on different weld paths on the same secondary component, provided that they are formed in locations sufficiently spaced from one another so as to not thermally influence the previous spot weld(s) that have not yet solidified, e.g. where the respective spot weld locations are >1 mm apart. Lasers also suffer a severe materials-related drawback in that materials such as copper and aluminium reflect laser radiation, which affects weld consistency in terms of penetration and overall quality.

Once all of the required spot welds have been formed, a set of contiguous spot welds will extend along each of the weld paths so as to form an extended line (or area) along (or across) which the primary component and the respective secondary component are joined together by the resulting weld. Because each successive spot weld may only be formed after the or each (if any) other spot welds with which it is contiguous have solidified, the “humping” effect described previously, which arises when an electron beam is used to form an extended weld by melting the corresponding area of the material all at once, does not occur. Mitigating the “humping” effect in this way greatly increases the consistency of the resulting welds since the individual spot welds form and solidify in a reliable, consistent manner and are not susceptible to the kind of chaotic behaviour associated with humping in extended welds. The resulting improvement in consistency is particularly beneficial where the produced welds are intended to serve as electrical connections joining battery cells to a current collector, since this will help to ensure that substantially the same current is drawn from each cell in use, thus improving the performance and lifetime of the cells and the battery assembly as a whole.

Because each of the secondary components are joined to the same primary component, the method results in a complex product in which each secondary component is joined to the primary component by a respective weld (or welds, since each secondary component could be joined to the primary component by a plurality of welds each defined by a respective weld path). As noted above and as will be further discussed later, the product formed by the assembled primary and secondary components may be a battery assembly for an electric vehicle. For example, the secondary components may be electrical cells which are each to be welded to a primary component such as a current collector. However, the advantages of the present invention are not limited to this context since the high weld speeds and consistent, high-quality joins that it achieves will be beneficial in any setting that requires joining a plurality of secondary components to a primary component.

In preferred embodiments, each weld path each comprises a respective plurality of segments each comprising a respective plurality of the spot weld locations, wherein the sequence in which the spot welds are formed is such that within each segment, each successive spot weld in the segment is only formed after the or each previous spot weld in the segment has solidified. In these embodiments, each segment defines a distinct region of space which contains the respective plurality of spot weld locations. While the segments of each weld path are distinct regions of space, they may partially overlap one another, or may abut (such that they are in contact with no overlap) or be laterally spaced from one another (such that two adjacent segments are separated by an intervening region of space), provided that the spot welds formed at the spot weld locations of the weld path form a contiguous set as defined above. Dividing the weld paths into segments in this manner provides an effective way of allowing the spot welds of each weld path to be produced in the required manner, i.e. forming each spot weld while the previously-formed one is solidifying but such that it is not contiguous with any other spot welds that have not yet solidified, while not needing to traverse the electron beam onto another weld path before completing the weld path in question. Instead of traversing the beam between different weld paths in order to form successive weld spots, the beam can simply be traversed between different segments of the same weld path. This reduces the distance the total distance that the beam is required to traverse in order to complete the weld path and hence reduces the time taken to form it. For example, the weld path could have the form of a circular loop divided into a plurality of segments. In order to form the weld defined by this weld path, the electron beam could be traversed from one segment to the next (e.g. in a clockwise fashion), forming one spot weld in each segment before traversing to the next. After forming one spot weld in each segment, the electron beam will return to the first segment and then form a spot weld at the next spot weld location within that segment at which a spot weld has not yet been formed.

As will be apparent from the “circular loop” example just described, in the embodiments in which the weld paths are divided into segments, it is particularly preferred that the sequence in which the spot welds are formed is such that after forming a spot weld in any one of the segments, the immediate next spot weld formed is in a different one of the segments. This is not strictly essential, however, since two or more spot welds in a row may be formed in the same segment, provided that they are not formed contiguous with an earlier spot weld which has not yet solidified.

In preferred implementations, each weld path defines a line or loop. Herein, the term “line” encompasses any path with two distinct end points, including rectilinear paths (for example those formed by a plurality of connected sections straight line, such as a “Z” shape). For example, straight lines and curves fall within this definition. A “loop” is a closed path, for example the perimeter of a shape such as a circle or square.

Preferably at least some, more preferably all, of the weld paths have the same shape as one another. In these embodiments, the orientation of this same shape may differ between weld paths, or could be the same for each weld path. Particularly in the case of joining a large number of identical components, it is advantageous that the shape, or ‘motif’ pattern, used to join their respective workpieces will be the same, even if orientation of the motif may change based upon the different rotational positions of the workpieces, for example where the components are individual cells arrayed in a battery tray. Forming some or all of the weld paths with the same shape can be advantageous as it ensures that the properties of the joins formed by the resulting welds are consistent. This is particularly beneficial where the welds are intended to form electrical connections (for example those connecting electrical cells to a current collector).

At least some of the spot welds joining the primary component and the second secondary component may be formed before the last of the spot welds joining the primary component and the first secondary component has been formed. In this case, the electron beam will be traversed between first and second secondary components (possibly going via other additional secondary components, if provided) before completing either weld path.

In some preferred embodiments, steps (a) and (b) are repeated alternately such that each successive spot weld on the first weld path is formed before at least the previous spot weld formed on the second weld path has solidified, and vice-versa.

In some preferred embodiments, at least one, more preferably each, of the successive spot welds formed is contiguous with, preferably partially overlapping, a respective previous spot weld which has solidified. This causes the welds joining the secondary components to the primary component to form in an ordered manner, which improves the consistency of the joins between the secondary and primary components. It can also result in at least some of the spot welds of the weld paths in question being formed in the order in which they are arranged along the weld path.

As noted above, a preferred application for the methods above is the joining of electric vehicle battery pack components, such as the various electrical connections required from cells to collector plates and tabs, and collector plate to busbar connections; heat sink connections; and mechanical connections. The benefits of the invention are felt particularly strongly in this context. Hence, in preferred embodiments, some or all of the secondary components are battery cells for a vehicle battery and the primary component is a current collector. In the totality of a battery pack for an electric vehicle, it is feasible that the pack could be provided as multiple groups comprising of a primary component (current collector) and secondary components (battery cells) in a modular fashion, where the different modules are electrically interconnected and controlled by a battery management system.

Since, for the reasons described previously, the invention enables very large numbers of secondary components to be rapidly joined to a primary component, the number of secondary components to be welded to the primary component is preferably at least 10, more preferably at least 100, most preferably at least 1000. Because the invention achieves high weld speeds for the reasons discussed previously, the overall time saved in manufacturing each assembly of components by the method of the invention will increase with the number of secondary components to be joined to the primary component.

Since electron beams of the kind which may be used to perform the method of the invention can be traversed so rapidly, there is no particular requirement to reduce beam power during a traverse, and preferably the beam may be left ‘on’, although power can of course be adjusted to suit different material types and workpiece thicknesses. Hence, preferably, the electron beam welding is performed using an electron beam which remains on when traversing between spot weld locations. For example, the power of the beam may be kept substantially constant, or at least maintained at some non-zero level, while traversing. Because electron beams can be traversed very rapidly, traversing the electron beam while “on” results in almost no power wastage and does not risk melting material on the path along which the electron beam is traversed between spot weld locations.

As noted above, methods in accordance with the invention have been found to achieve very high weld speeds and hence the electron beam welding is preferably performed with an effective welding speed of at least 500 millimetres per second, mm/s, more preferably at least 1000 mm/s, most preferably at least 2000 mm/s. Effective welding speed is calculated by dividing the distance along any given weld path covered by at least two contiguous spot welds by the time taken to form that number of spot welds. As will be shown with reference to an example later, the distance along a weld path covered by two or more contiguous spot welds is not necessarily the sum of the distances along the weld path covered by each individual spot weld, since the contiguous spot welds may partially overlap one another (to an extent which depends on the size of the spot welds and their spacing along the weld path). In many applications, to be feasible as a joining process, ideally joints produced must be continuous and of a consistent joint pattern. For example, when comparing to laser welding, laser galvanometers take around 1 millisecond to settle, so at absolute best it is not possible to create more than 10 spots in 10 milliseconds, making the fastest effective welding speed 200 millimetres per second, even without accounting for the distance ‘lost’ to spot overlap. This settling/speed limitation for laser means it is not industrially feasible to apply the lasers in a similar fashion to the electron beam method disclosed here, as no advantage would be gained over forming continuous seams.

In preferred implementations, the electron beam welding is performed under vacuum conditions, preferably at a pressure of less than 10⁻² millibar (mbar), more preferably less than 10⁻³ mbar. Performing the welding under these conditions avoids significant scattering of the electrons by the atmosphere, which maximises the efficiency with which power is delivered to the area on which the beam is focused and allows the profile and dimensions of the beam to be more precisely controlled. It also prevents pollution of the molten materials and the resulting welds by substances in the atmosphere.

As noted above, the method is applicable to welding any plural number of secondary components to the primary component. Hence, in preferred embodiments, the plurality of secondary components further comprises one or more additional secondary components in addition to the first and second secondary component, and wherein the method further comprises, for each of one or more additional secondary components: (c) on a respective weld path which defines a respective section of the primary component to be welded to the respective additional secondary component, forming, by electron beam welding, a spot weld which joins together the primary component and the respective additional secondary component at a respective spot weld location on the respective weld path; wherein step (c) is repeated at least once, in any order with respect to steps (a) and (b) and step (c) as performed for the other additional secondary components, so as to form, on the respective weld path, a set of contiguous spot welds arranged along the respective weld path, wherein each successive spot weld is formed while one or more of the previous spot welds is solidifying and only after any existing spot weld(s) with which it is contiguous has solidified. Since steps (a), (b) and (c) are repeated in any order, the spot welds of the weld paths of the first and second secondary components and the or each additional secondary components may be formed in any order (subject to the requirement that each spot weld is not formed contiguous with any previous spot weld that has not yet solidified).

A second aspect of the invention provides an apparatus for electron beam welding a plurality of secondary components to a primary component, the apparatus comprising:
an electron beam source configured to generate, in use, an electron beam for electron beam welding;
a component holder adapted to hold, in use, the secondary components in position for welding to the primary component;
a beam steering module operable to control the path of the electron beam for welding together the primary and secondary components; and
a controller configured to operate the beam steering module to perform the following steps:
(a) on a first weld path which defines a respective section of the primary component to be welded to a first secondary component, forming, by electron beam welding, a spot weld which joins the primary component and the first secondary component at a respective spot weld location on the first weld path;
(b) on a second weld path which defines a respective section of the primary component to be welded to a second secondary component, forming, by electron beam welding, a spot weld which joins together the primary component and the second secondary component at a respective spot weld location on the second weld path; and
repeating each of steps (a) and (b) at least once, in any order, so as to form, on each of the first and second weld paths, a respective set of contiguous spot welds arranged along the respective weld path, wherein each successive spot weld is formed while one or more of the previous spot welds is solidifying and only after any existing spot weld(s) with which it is contiguous has solidified.

The beam steering module may be any device or set of devices capable of influencing the at least the direction. It may also be capable of controlling the distance along the path of the electron beam at which it is focused and/or the cross-sectional shape and dimensions of the electron beam. Typically these functions will be performed by electrical coils that generate magnetic fields in the vicinity of the electron beam in order to control the parameters of the beam as required. The controller could be a computer, for example. An example of an electron beam source suitable for use in apparatus and methods in accordance with embodiments of the present invention is described by WO-A-2013/186523.

Preferably the beam steering module comprises a lens coil assembly controllable to focus the electron beam onto the spot weld locations of the spot welds to be formed. Since the spot weld locations will typically be at different distances from the electron beam source, being able to focus the electron beam in this way enables the beam to be controlled such that its cross-sectional area is the same at each spot weld location. This enables the spot welds to be formed with a high degree of consistency.

In preferred embodiments the beam steering module comprises a deflection coil assembly controllable to traverse the electron beam across the area in which the spot welds are to be formed. Traversing the electron beam using this coil assembly could involve changing the current through the coils in order to alter the strength and/or geometry of the electromagnetic field generated by them, which will in turn change the trajectory followed by the electron beam moving through it.

Advantageously, the beam steering module may comprise a stigmator coil assembly controllable to change the cross-sectional shape and/or size of the electron beam. This allows the dimensions of the spot welds formed by the electron beam controlled (since the dimensions of the spot welds are influenced by the shape and size of the electron beam's cross-section), and also allows the beam to be controlled to achieve consistent formation of spot welds when the surface geometry, angle of incidence between the beam and surface or other parameters vary between spot weld locations.

Each of the coil assemblies described above may be constructed so as to optimise the speed at which they can be adjusted, for example using ferrite magnetic cores to avoid eddy currents. They may be driven by high frequency response current amplifiers and can be constantly adjusted to provide the optimum beam intensity at the workpiece.

The controller may be further configured to operate the beam steering module to perform any of the optional steps described above with respect to the first aspect of the invention.

A third aspect of the invention provides a welded assembly of a primary component and at least two secondary components, wherein each secondary component is joined to the primary component by one or more sets of contiguous spot welds. Such an assembly may be made by methods in accordance with the first aspect of the invention and any of the preferred features thereof as defined above. In assemblies in accordance with the third aspect of the invention, in terms of the longitudinally sectioned microstructure of joints formed from contiguous spots versus a seam weld, it is discernible that joint formed from contiguous spots will have multiple identifiable solidification boundaries i.e. at least one for each spot weld formed, whereas the joint formed from a seam weld would have only boundaries surrounding the seam as a whole.

### BRIEF DESCRIPTION OF THE DRAWINGS

Examples of methods and apparatus in accordance with embodiments of the invention will now be described with reference to the accompanying drawings, in which:

FIG. 1 shows a plan view of a section of a typical electric vehicle battery pack, the components of which may be joined by methods in accordance with embodiments of the invention;

FIG. 2 shows a plan view of a small subset of the cells of FIG. 1 being operated on in accordance with an embodiment of the invention;

FIG. 3 shows a schematic cross-section through a primary component and a secondary component joined by a method in accordance with an embodiment of the invention;

FIG. 4 shows a schematic of effective weld speed calculation;

FIG. 5 shows an example of a weld path defining a set of spot welds which may be formed when performing methods in accordance with the invention;

FIG. 6 shows schematically an example of an apparatus in accordance an embodiment of with the present invention.

### DETAILED DESCRIPTION

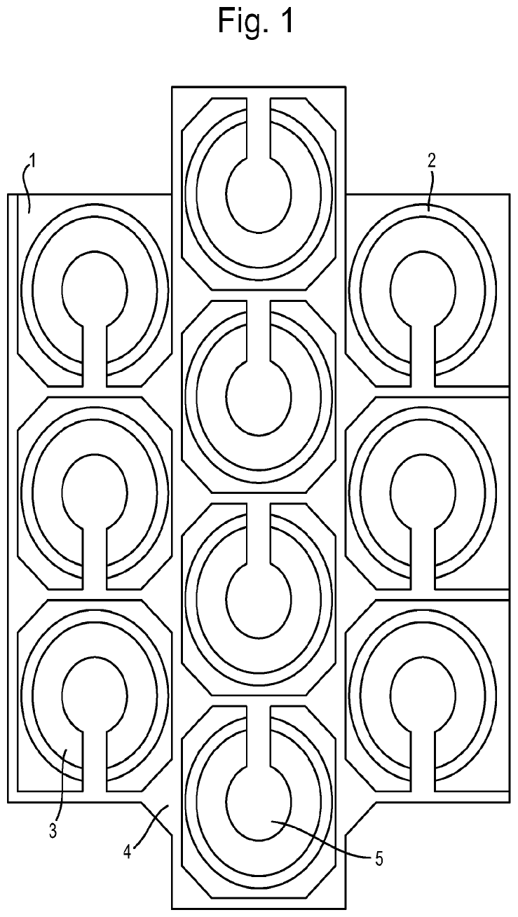

In FIG. 1 there is shown a small section of a battery pack with a number of cells, each of which is a secondary component. The main structural body of the pack 1 (typically comprising an aluminium tray and reinforcing elements) contains and mechanically supports the battery cells, in this example cylindrical cells with steel cases 2 and copper terminals 3. The cells are electrically connected to a collector plate 4, which is a primary component and which spans the cells and in this case is aluminium. The collector plate has connecting tabs 5, which are to be joined to the cell terminals 3. The cells in this case are electrically connected in parallel, where the collector plate 4 connects to the electrically positive terminals 3, whilst another arrangement (not shown) is provided for the negative terminals. It is feasible for positive and negative collector plates to be arranged on the same surface, as long as there is sufficient electrical separation, or the collector plates could be provided on different (e.g. opposite ends of the cell, or parallel to the cell long axis) surfaces.

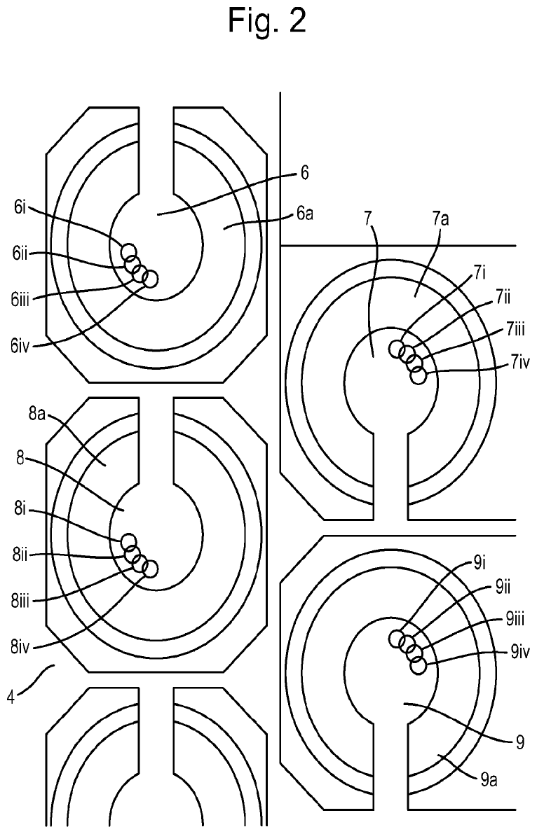

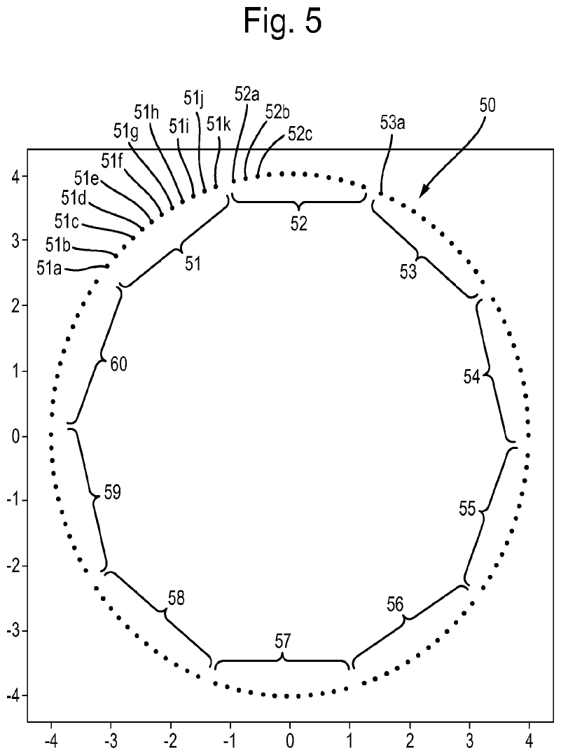

FIG. 2 illustrates a joining process in accordance with an embodiment of the invention, where there is shown a small subset of cells (each of which is a secondary component) in a battery pack joined to the collector plate 4 (which is the primary component in this example) at each connector tab location. An electron beam is manipulated to join each connector tab to the corresponding cell by forming individual spot welds in sequence. In the simple example shown here, collector plate connection tabs 6, 7, 8, and 9 are to be joined to their respective cell terminals 6a, 7a, 8a, and 9a. For each connection tab 6, 7, 8, 9 and corresponding cell terminal 6a, 7a, 8a, 9a, a respective weld path is defined, which comprises a plurality of spot weld locations arranged along the weld path and defines a section of the respective cell terminal 6a, 7a, 8a, 9a to be welded to the collector plate 4. In the language by which the first aspect of the invention was defined above, the cell with cell terminal 6a could be the first secondary component and the cell with cell terminal 7a the second secondary component, with the other cells (with cell terminals 8a, 9a, etc.) each being an additional secondary component. It will be appreciated in light of this example that the electron beam may in general be traversed between the weld paths in any order, forming one or possibly more (e.g. in the case where the weld path is divided into segments, an example of which will be described with reference to FIG. 5 below) spot welds on each weld path before moving to the next.

In this example, the electron beam forms spot welds in the sequence 6i-7i-8i-9i, 6ii-7ii-8ii-9ii. 6iii-7iii-8iii-9iii. 6iv-7iv-8iv-9iv and so on until the desired joint pattern is formed. In other words, the electron beam moves from one weld path to the next (e.g. from the weld path on connection tab 6 to that on connection tab 7, and so on), forming one spot weld on each, before returning to the first weld path (on the connection tab 6). In this example, the spot welds shown are arranged along circular arcs, so the weld paths in accordance with which they are formed could each have the shape of a part or whole of the perimeter of a circle, such as will be described below with reference to FIG. 5. The weld paths could however have other shapes, for example a straight line or “Z” shape.

The electron beam may be left on while traversing between spot weld locations, since this does not incur any significant power wastage. For simplicity, only four cells are shown with four spot welds each, but a more realistic and industrially-feasible case would likely involve greater than 1000 cells, each with a respective weld path shaped as, for example, a circle or other pattern enabling mechanically secure and electrically optimum connection.

An important characteristic of spot welds is the energy used per spot (measured in Joules) which is the product of beam power and duration of the spot. For shallow welds required for, for example, the battery tabs to battery terminals, where 200 to 400 micron depths may be required, spot weld energies of 0.25 J are typical. Applying methods in accordance with the invention to, for example, aluminium tab/collector plate to aluminium bus bar welding of a battery pack spot melt depth can be varied based upon electron beam parameters, such as beam current, spot size and spot dwell time. To penetrate 1.6 millimetres into aluminium using a spot size of 200 micrometres, an energy input of 2.4 Joules is required. To achieve this in, for example, 1 millisecond, 40 milliamps of beam current at 60 kilovolts is required.

Where material types vary, for example similar or dissimilar welds in copper, aluminium, steel and such like, achieving the required melt depth and joint quality will require adjustment of beam parameters and dwell times that are within the existing knowledge of the skilled electron beam machine operator.

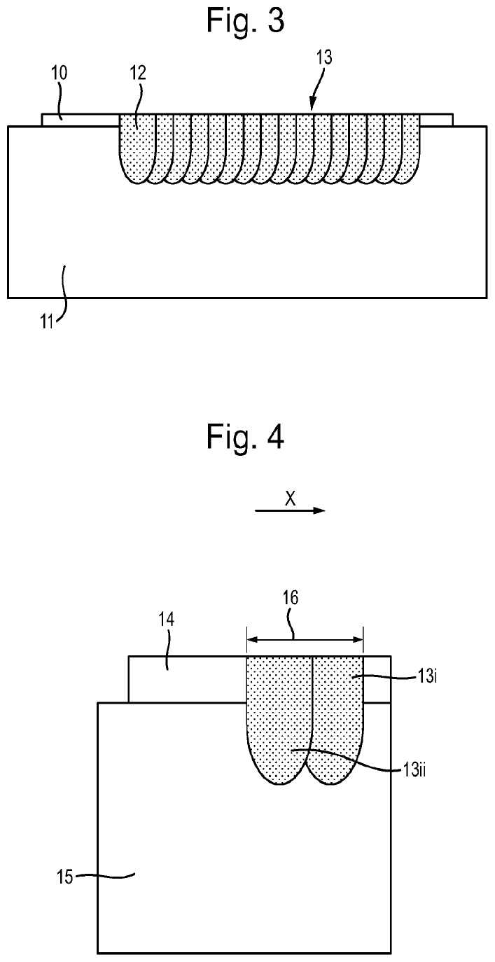

FIG. 3 schematically illustrates a cross-section through a single joined collector plate connector tab 10 (which may be part of the collector plate 4 described above, like the tabs 6, 7, 8 and 9 shown in FIG. 2) and cell terminal 11 with a linear array of spot welds. The last in sequence of individual, nominally identical spot welds 12 is shown. An individual freeze line 13, indicates where solidified spots overlap.

FIG. 4 schematically illustrates effective welding speed. In this case, only two spots 13i and 13ii adjacently located on a collector plate 14 to a secondary component 15 such as a bus bar are shown for ease of understanding. The effective weld speed may be calculated by dividing the distance 16 along the direction of the weld path X covered by the time taken to form any two spot welds (equivalent to beam impingement time). It should be noted that the distance 16 along the direction of the weld path X covered by the two spot welds 13i, 13ii is not equal to the sum of the sizes of the two spot welds 13i, 13ii along the same direction since there is some overlap between the two spot welds 13i, 13ii. When considering distance, this can be equated to the length of a weld seam if made by a continuous (not overlapping spot) process such as would be formed by moving the electron beam over the weld path in order to form an extended area of molten material. The foregoing principle for calculating the effective welding speed can be extrapolated to a realistic case for manufacture of battery cell connections in an electric vehicle battery assembly, where for example there are 50 spots on each of a 1,000 workpieces, and the time taken using slower joining methods will lead to a severe production bottleneck.

In addition to those noted above, further benefits of the invention include lack of sensitivity to material surface reflectivity, low sensitivity to beam deflection angle, vacuum operation leading to no interfering plumes, reliable operation, consistent weld creation and higher conductivity joints due to:
No reflectivity from materials such as copper or aluminium as is suffered by laser beams, which results in more consistent welding.
Effective joining rates of potentially greater than 1000 millimetres per second (which is on the order of 10 times the speed achievable by laser techniques and 100 times that achieved by wire bonding).
System cost not high when compared to cell and pack handling systems, and capital expenditure costs are likely to be outweighed by productivity/throughput gains made over the lifetime of the production system.

In terms of utilising the methods described herein to electric vehicle battery applications, apart from the cylindrical cell types illustrated, clearly other battery types (prismatic, pouch) can be joined as long as the joint areas are accessible to an electron beam. Whilst methods according to the invention are particularly advantageous for welding of battery packs for electric vehicle applications, clearly many applications requiring a large number of joints connecting a primary component to a plurality of secondary components are feasible.

In light of the foregoing examples, it will be apparent that performing methods in accordance with embodiments of the invention may entail the following features:
(a) Creating an individual melted region between a primary component and a first secondary component using the electron beam. This melted region is formed when the electron beam is fixed on any individual spot weld location, since the heat that it generates at the spot weld location causes the material at that location to melt. The resulting melted region will begin to solidify once the electron beam is removed, i.e. by traversing it to the spot weld location of the next spot weld to be formed.
(b) Traversing the electron beam to a second secondary component and creating an individual melted region between that component and the primary component using the electron beam. Similar to feature (a) above, the melted region here is formed at the spot weld location on the second secondary component upon which the electron beam is fixed, thus forming a spot weld joining the primary component and the second secondary component, which will begin to solidify once the electron beam has been removed.
(c) Traversing the electron beam to the first secondary component and creating an additional melted region between that component and the primary component, whereby the previous melted region on that component has been allowed to solidify. In other words, once the spot weld resulting from the melted region formed by feature (a) has been formed, the electron beam may be fixed on another weld location on the first secondary component to form another spot weld (possibly after forming one or more spot welds one some or all of the other secondary components to be joined to the primary component).
(d) Traversing the electron beam to the second secondary component and creating an additional melted region between that component and the primary component, whereby the previous melted region on that component has been allowed to solidify. This melted region will form a spot weld joining the second secondary component to the primary component, and could be contiguous with the spot weld described with reference to feature (b), provided that this earlier spot weld (and any others contiguous with the spot weld to be formed) has solidified.
(e) repeating features (c) to (d) one or more times until the respective joining operations on the first and second components are complete.

As noted above, in some preferred embodiments, some or all of the weld paths may be divided into segments each comprising a plurality of the spot weld locations of the weld path. FIG. 5 shows an example of a weld path 50 and illustrates how the weld path 50 might be divided into segments for performing these preferred embodiments of the methods. The weld path 50 is substantially circular (and therefore forms a loop) and comprises a plurality of spot weld locations arranged along it, some of which are labelled, e.g. 51a, 51b, 51c, 52a, 53a. This circular weld path 50 could define the weld to be formed for joining each of the cell terminals 6a, 7a, 8a, 9a of FIG. 2 to the collector plate 4, for example, such that each cell terminal 6a, 7a, 8a, 9a would be joined to the collector plate 4 by a circular weld once the method has been completed.

In some embodiments, the order in which the spot welds are formed is not constrained by any requirement other than that each successive spot weld is formed (i) before the previously-formed spot weld has solidified, and (ii) is not contiguous with any other spot weld that has not yet solidified. Hence, in some embodiments, the electron beam may be manipulated in order to form the spot welds of the illustrated weld path 50 in any order, possibly also traversing to spot weld locations on one or more other weld paths before all of the spot welds to be formed on the weld path 50 in question have been formed. However, in the example shown, the weld path 50 is divided into a plurality of segments 51, 52, 53, 54, 55, 56, 57, 58, 59, 60, each of which comprises a plurality of spot weld locations. For example, segment 51 has 11 spot weld locations 51a, 51b, 51c, 51d, 51e, 51f, 51g, 51h, 51i, 51j, 51k. In this example, each of the other segments 52, 53, 54, 55, 56, 57, 58, 59, 60 also includes 11 spot locations, although it is not essential that each segment has the same number of spot weld locations in all cases.

The spot welds of the weld path 50 may be formed in an order such that each successive spot weld is formed in a different weld path to the previous one: for example, the first spot weld may be formed at spot weld location 51a in segment 51, the next at spot weld location 52a in segment 52, the next after that at spot weld location 53a in segment 53, and so on, forming one spot weld in each segment and then traversing the electron beam clockwise to the next, until one spot weld has been formed in each of the segments 51-60. The electron beam could then be traversed to spot weld location 51b, where the next spot weld may be formed, and then spot weld location 52b, and so on, again moving clockwise from one segment to the next, forming a spot weld in each before moving to the next. This provides a simple way of ensuring that no spot weld is formed contiguous with an earlier spot weld which has not yet solidified and, because of the ordered pattern in which the spot welds are formed, improves the consistency of the resulting connection between the primary component and the secondary component in question. While in this example the weld path 50 is circular, it will be apparent that a weld path in the form of a line, curve or any other form could be divided into segments by the same principle.

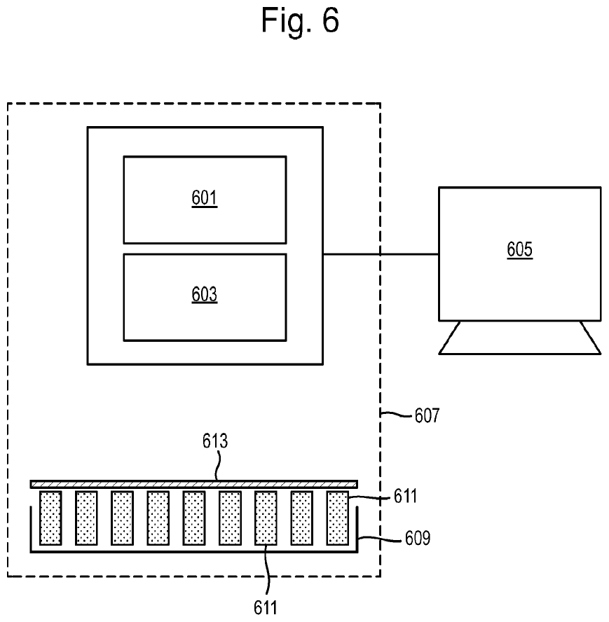

FIG. 6 shows schematically an apparatus in accordance with an embodiment of the invention. The apparatus includes an electron beam source 601, for example as disclosed in WO-A-2013/186523, and a beam steering module 603. The apparatus also includes a component holder 609, which is adapted to hold a plurality of secondary component 611 to be welded to a primary component 613 in use. In this example the electron beam source 601, beam steering module 603 and component holder 609 are inside a processing chamber 607, which may be adapted to produce a vacuum or partial vacuum in use.

The electron beam source 601 and beam steering module 603 are in communication with a controller 605, for example a computer processor, which is configured to control the beam steering module to perform the methods described above with reference to FIGS. 1-5 in order to join the secondary components 611 to the primary component 613.

The beam steering module 603 is operable to control the path of the electron beam generated by the electron beam source 601 and preferably includes one or more of a lens coil assembly for focusing the electron beam onto the components held by the component holder 609; a deflection coil assembly for traversing the electron beam laterally across the held components; and a stigmator coil assembly for controlling the cross-sectional size and/or shape of the electron beam. Each of these coil assemblies may be controlled by the controller 605.

In use, the electron beam generator 601 generates an electron beam whose path is controlled by the beam deflection module 603, based on instructions from the controller 605, in order to weld each of the secondary components 611 to the primary component 613. The electron beam will thus be manipulated by the beam steering module 603 in order to produce, for each secondary component 611, one or more sets of contiguous spot welds (the arrangement of each set being defined by the weld path on which the respective spot welds lie) joining the secondary component 611 to the primary component 613.

1. A method of electron beam welding a plurality of secondary components to a primary component, the method comprising:
(a) on a first weld path which defines a respective section of the primary component to be welded to a first secondary component, forming, by electron beam welding, a spot weld which joins the primary component and the first secondary component at a respective spot weld location on the first weld path;
(b) on a second weld path which defines a respective section of the primary component to be welded to a second secondary component, forming, by electron beam welding, a spot weld which joins together the primary component and the second secondary component at a respective spot weld location on the second weld path; and
repeating each of steps (a) and (b) at least once, in any order, so as to form, on each of the first and second weld paths, a respective set of contiguous spot welds arranged along the respective weld path, wherein each successive spot weld is formed while one or more of the previous spot welds is solidifying and only after any existing spot weld(s) with which it is contiguous has solidified.

2. The method of claim 1, wherein each weld path comprises a respective plurality of segments each comprising a respective plurality of the spot weld locations, wherein the sequence in which the spot welds are formed is such that within each segment, each successive spot weld in the segment is only formed after the or each previous spot weld in the segment has solidified.

3. The method of claim 2, wherein the sequence in which the spot welds are formed is such that after forming a spot weld in any one of the segments, the immediate next spot weld formed is in a different one of the segments.

4. The method of claim 1, wherein each weld path defines a line or loop.

5. The method of claim 1, wherein at least some, preferably all, of the weld paths have the same shape as one another.

6. The method of claim 1, wherein at least some of the spot welds joining the primary component and the second secondary component are formed before the last of the spot welds joining the primary component and the first secondary component has been formed.

7. The method of claim 1, wherein steps (a) and (b) are repeated alternately such that each successive spot weld on the first weld path is formed before at least the previous spot weld formed on the second weld path has solidified, and vice-versa.

8. The method of claim 1, wherein at least one, preferably each, of the successive spot welds formed is contiguous with, preferably partially overlapping, a respective previous spot weld which has solidified.

9. The method of claim 1, wherein some or all of the secondary components are battery cells for a vehicle battery and the primary component is a current collector.

10. The method of claim 1, wherein the number of secondary components to be welded to the primary component is at least 10, preferably at least 100, more preferably at least 1000.

11. The method of claim 1, wherein the electron beam welding is performed using an electron beam which remains on when traversing between spot weld locations.

12. The method of claim 1, wherein the electron beam welding is performed with an effective welding speed of at least 500 millimetres per second, mm/s, preferably at least 1000 mm/s, more preferably at least 2000 mm/s.

13. The method of claim 1, wherein the electron beam welding is performed under vacuum conditions, preferably at a pressure of less than 10⁻² millibar (mbar), more preferably less than 10⁻³ mbar.

14. The method of claim 1, wherein the plurality of secondary components further comprises one or more additional secondary components in addition to the first and second secondary component, and wherein the method further comprises, for each of one or more additional secondary components:
(c) on a respective weld path which defines a respective section of the primary component to be welded to the respective additional secondary component, forming, by electron beam welding, a spot weld which joins together the primary component and the respective additional secondary component at a respective spot weld location on the respective weld path; wherein step (c) is repeated at least once, in any order with respect to steps (a) and (b) and step (c) as performed for the other additional secondary components, so as to form, on the respective weld path, a set of contiguous spot welds arranged along the respective weld path, wherein each successive spot weld is formed while one or more of the previous spot welds is solidifying and only after any existing spot weld(s) with which it is contiguous has solidified.

15. An apparatus for electron beam welding a plurality of secondary components to a primary component, the apparatus comprising:
an electron beam source configured to generate, in use, an electron beam for electron beam welding;
a component holder adapted to hold, in use, the secondary components in position for welding to the primary component;
a beam steering module operable to control the path of the electron beam for welding together the primary and secondary components; and
a controller configured to operate the beam steering module to perform the following steps:
(a) on a first weld path which defines a respective section of the primary component to be welded to a first secondary component, forming, by electron beam welding, a spot weld which joins the primary component and the first secondary component at a respective spot weld location on the first weld path;
(b) on a second weld path which defines a respective section of the primary component to be welded to a second secondary component, forming, by electron beam welding, a spot weld which joins together the primary component and the second secondary component at a respective spot weld location on the second weld path; and
repeating each of steps (a) and (b) at least once, in any order, so as to form, on each of the first and second weld paths, a respective set of contiguous spot welds arranged along the respective weld path, wherein each successive spot weld is formed while one or more of the previous spot welds is solidifying and only after any existing spot weld(s) with which it is contiguous has solidified.

16. The apparatus of claim 15, wherein the beam steering module comprises a lens coil assembly controllable to focus the electron beam onto the spot weld locations of the spot welds to be formed.

17. The apparatus of claim 15, wherein the beam steering module comprises a deflection coil assembly controllable to traverse the electron beam across the area in which the spot welds are to be formed.

18. The apparatus of claim 15, wherein the beam steering module comprises a stigmator coil assembly controllable to change the cross-sectional shape and/or size of the electron beam.

19. The apparatus of claim 15, wherein the controller is further configured to perform the method of claim 2.
